(19) United States
(12) Patent Application Publication
(10) Pub. No.: US 2014/0270449 A1
(43) Pub. Date: Sep. 18, 2014

(54) INTERACTIVE METHOD TO ASSESS JOINT SPACE NARROWING

(71) Applicants: John Andrew HIPP, Houston, TX (US); James M. ZIEGLER, Houston, TX (US); Nicholas D. WHARTON, Houston, TX (US); Patrick NEWMAN, Houston, TX (US)

(72) Inventors: John Andrew HIPP, Houston, TX (US); James M. ZIEGLER, Houston, TX (US); Nicholas D. WHARTON, Houston, TX (US); Patrick NEWMAN, Houston, TX (US)

(21) Appl. No.: 14/213,635

(22) Filed: Mar. 14, 2014

Related U.S. Application Data
(60) Provisional application No. 61/799,345, filed on Mar. 15, 2013.

(51) Int. Cl. G06T 7/00

(52) U.S. Cl. CPC G06T 7/0014
USPC 382/131

(57) ABSTRACT

A system is configured to assess joint space narrowing and includes a processor communicatively coupled to a display, non-transitory memory and a user input. The processor is configured for receiving at least two images and designating one image as a reference image and another image as a target image. Then, alternating whether the reference image or the target image is displayed on the display. After that, receiving common objects on the target image and the reference image from the user input. Next, embedding the common objects as anatomical landmarks on the reference image and the target image. Following that, receiving transformation instructions from the user input changing an appearance of the target image. Then, loading the transformation instructions into a transformation matrix. Finally, determining the joint space narrowing from the transformation instructions in the transformation matrix.

### RELATED APPLICATION

This application claims priority to provisional patent application U.S. Ser. No. 61/799,345 filed on Mar. 15, 2013, the entire contents of which is herein incorporated by reference.

### BACKGROUND

The embodiments herein relate generally to procedures used to configure diagnostic equipment.

Healthy joints have articular cartilage that acts as a cushion within the joint such that pressure on the joint is absorbed, to some extent, by the cartilage. Over time and for a variety of reasons, the articular cartilage can deteriorate thus causing the space between bones in the joint, called joint space, to narrow. This process is joint space narrowing.

Assessing joint space in absence of other factors simply involves medical imaging. However, determining a time derivative of the joint space, that is the joint space narrowing, has evaded a simple solution. Part of the reason for this is that imaging can be inconsistent. A joint can be shown on a different scale, rotated slightly between two images, or have other inconsistences that can affect determination of this time derivative. Embodiments of the disclosed invention solve this problem.

### SUMMARY

A system is configured to assess joint space narrowing and includes a processor communicatively coupled to a display, non-transitory memory and a user input. The processor is configured for receiving at least two images and designating one image as a reference image and another image as a target image. Then, alternating whether the reference image or the target image is displayed on the display. After that, receiving common objects on the target image and the reference image from the user input. Next, embedding the common objects as anatomical landmarks on the reference image and the target image. Following that, receiving transformation instructions from the user input changing an appearance of the target image. Then, loading the transformation instructions into a transformation matrix. Finally, determining the joint space narrowing from the transformation instructions in the transformation matrix.

In some embodiments, the processor instructions also include recalling previously tracked common objects from the non-transitory memory and displaying the previously tracked common objects on the display. In some embodiments, the processor instructions also include clearing the common objects that have been tracked and tracking new common objects. In some embodiments, the at least two images are obtained by obtained from or by one of: X-ray scattering, computer tomography, X-ray computed tomography and ultrasound.

### BRIEF DESCRIPTION OF THE FIGURES

The detailed description of some embodiments of the invention is made below with reference to the accompanying figures, wherein like numerals represent corresponding parts of the figures.

FIG. 1 shows a schematic process view of an embodiment of the invention.

FIG. 2 is a view a sagittal plane slice of a knee joint image.

FIG. 3 is a view of a reference image and a target image that have been stabilized.

FIG. 4 shows a sagittal plane slice of a region of interest.

FIG. 5 shows schematic process view of an embodiment of the invention.

FIG. 6 shows schematic process view of an embodiment of the invention.

FIG. 7 conceptually illustrates an electronic system with which some embodiments of the invention are implemented.

### DETAILED DESCRIPTION OF CERTAIN EMBODIMENTS

There is no shortage of equipment that could perform the disclosed method, but for the sake of simplicity, the method refers to a processor communicatively coupled to memory wherein the memory is a non-transitory computer readable memory or simply non-transitory memory. The processor is configured to execute instructions as explained below. The processor is communicatively coupled to a display. The display is configured to show electronic images as directed by the processor. This system can be operated by a user using a user input, such as a keyboard, mouse, touchscreen, or any other known user input.

By way of example, and referring to FIG. 1, one embodiment of the present process includes the following steps, which are not necessarily in order. An operator inputs at least two images into the memory. The images can be obtained from or by X-ray scattering (X-ray), computer tomography (CT Scan), X-ray computed tomography (x-ray CT), ultrasound or any other known body imaging technique. There are three ways to use this information. The first way is where the variety of loading conditions. For instance, the first image is with and unloaded joint and the second image is of a joint under load. Second, the first image is taken at a first time and the second image is taken at a second time, which is subsequent to the first time. Third is a combination of the first and second technique where times and loads are varied.

Of the images captured one image is established as a reference image. Another image is designated as the target image. The operator then alternately displays the reference image and the target image on the display.

While the images are alternately displayed the operator identifies features of a specific object common to both images. The operator changes the appearance of the target image relative to the reference image, and then loads the reference image again. This change in appearance can include moving, scaling, rotating, translating or otherwise adjusting the target image. In some embodiments, these transformation instructions can originate from one of specific keystrokes, mouse movements, manipulations using a track pad, or finger movements on a touchscreen to move either the target image or the reference image.

The target image interpreted until features that are common to both images, relative to the reference image, remain in a constant position and appearance on the display as the target image and reference image are alternately displayed.

The target image is placed in a grid that can be actually displayed on the screen or invisible but otherwise present on the screen. The grid also has an initial scale such that features of a bone can be measured. While the target image is being adjusted, those adjustments are being recorded in a transformation matrix. In general, every time a user rotates, translates, or scales the target image, the information required to do the transformation is accumulated into a table of numbers. This table, or matrix contains all the information needed to do any series of transformations. The goal of these transformation instructions is to have a specific feature or object remaining in a constant position and a constant size on the display.

The transformation matrix is stored in an electronically readable form so that it may be recalled and used to stabilize specific previously tracked objects, or to calculate relative motions between tracked objects. At this point the use can choose to track more objects as desired. If this is desired than additional objects can be tracked with the steps listed above. If this is not desired, then relative motions between specific bones or features in the target image and the reference image are calculated using mathematical operations on the multiple mathematical transformation matrices generated by the preceding step.

### EXAMPLE 1

### Manual Arrangement of the Images

FIG. 2 and FIG. 3 show an example of the disclosed process with a human knee. Distal femur 10 is immediately adjacent to femur cartilage 12. Femur cartilage 12 is proximate tibia cartilage 14. Tibia cartilage 14 is immediately adjacent to proximal tibia 16. Joint space here, can be defined as the space between distal femur 10 and proximal tibia 16.

Reference image 18 and target image 20 are taken with, for example an x-ray and placed in the memory.

Reference image 18 shows the knee without load while target image 20 shows the knee with load. Applying the method above, an operator first views reference image 18 and then target image 20 to discern if there are similar anatomical landmarks 22. To distinguish between reference image 18 and target image 20, reference image 18 has first background color 24 whereas target image 20 has second background color 26. In some embodiments, first background color 24 is green and second background color 26 is red.

This process can be known as viewing the images in an alternating manner and finding common objects. There can be more than one set of common objects in memory. The previously stored common objects can be recalled as desired by the operator. Once the similar anatomical landmarks 22 are discerned, they can be marked on reference image 18 and then target image 20.

After marking anatomical landmarks 22 distal femur 10 and proximal tibia 16, the operator can then transform target image 20 such that anatomical landmarks 22 on distal femur 10 in reference image 18 and target image 20 are identically aligned. At this stage the effect of loading on the knee can be measured and the presence or absence of joint space narrowing can be precisely calculated.

### EXAMPLE 2

### Manual Adjustment with Match Score

The arrangement of images need not be manual. FIG. 5 proposes a method where the arrangement of images is automatic. As above, the operator inputs at least two images into the memory. On image is designated as reference image 18 and another image is designated as target image 20. The operator then defines region of interest 30 as shown in FIG. 4 in both reference image 18 and target image 20. Region of interest 40 is a region showing a distal portion of at least one bone preferably marked by anatomical landmarks 22, though that is not required.

The target image region of interest 40 is then compared to the reference image region of interest 40. The computer calculates a match score between the target image region of interest 40 and the reference image region of interest 40. In some embodiments, a match score compares the target image region of interest 40 and the reference image region of interest 40, pixel-by-pixel within region of interest 40, using an equation for a coefficient such as the Jaccard Index. The Jaccard index is calculated by binarizing the images and determining the percent of pixels where both the target image region of interest 40 and the reference image region of interest 40 are 1 (versus 0).

As above, a user can now make a minor alteration to target image 20. While target image 20 is being adjusted, those adjustments are being recorded in a transformation matrix as above. Additionally, the effectiveness of the transformation matrix is constantly update by continually recalculating the match score.

The transformation matrix is stored in an electronically readable form so that it may be recalled and used to stabilize specific previously tracked objects, or to calculate relative motions between tracked objects. At this point the use can choose to track more objects as desired. If this is desired than additional objects can be tracked with the steps listed above.

### EXAMPLE 3

### Manual Adjustment with Automatic Correction

In some instances, it can be helpful for a user to have the computer make minor modifications to align images. FIG. 6 demonstrates such a process.

As above, the operator inputs at least two images into the memory. On image is designated as reference image 18 and another image is designated as target image 20. The operator then defines region of interest 30 as shown in FIG. 4 in both reference image 18 and target image 20.

The operator alternately displays the image and makes a first approximate adjustment. At this point, the computer tests every possible combination of translations and rotations of target image 20 with respect to the reference image 18, within a predefined range. In some examples the predefined range can include movements of up to 5 mm and rotations of up to 5 degrees in any direction. After each possible combination of a translation and a rotation is implemented, the computer calculates a match score, using any known method such as the Jacquard Index discussed above. After all possible combinations of translations and rotations is tested, the computer chooses the combination that gives the highest match score. The operator may then assesses the quality of tracking and makes adjustments as needed using the previously described invention.

A mathematical transformation matrix is calculated describing the transformation necessary to perform the combination described above. The transformation matrix is stored in an electronically readable form so that it may be recalled and used to stabilize specific previously tracked objects, or to calculate relative motions between tracked objects. At this point the use can choose to track more objects as desired. If this is desired than additional objects can be tracked with the steps listed above.

In some embodiments, upon acceptance by the operator of the stabilization of specific bones or features, one or more reports are produced in a standardized format providing the results for the present case. In some embodiments these reports include at least one of: reference data, graphs or figures to facilitate the interpretation of the data.

In some embodiments, quality assurance metrics can used to help the operator to identify errors during the tracking process. One example would be to alert the operator that the landmarks were applied in the wrong-order by recognizing that the measured joint space is smaller or larger than would be expected for the joint being tracked.

FIG. 7 conceptually illustrates an electronic system 200 with which some embodiments of the invention are implemented. The electronic system 200 may be a computer, phone, PDA, or any other sort of electronic device. Such an electronic system includes various types of computer readable media and interfaces for various other types of computer readable media. Electronic system 200 includes a bus 205, processing unit(s) 210, a system memory 215, a read-only 220, a permanent storage device 225, input devices 230, output devices 235, and a network 240.

The bus 205 collectively represents all system, peripheral, and chipset buses that communicatively connect the numerous internal devices of the electronic system 200. For instance, the bus 205 communicatively connects the processing unit(s) 210 with the read-only 220, the system memory 215, and the permanent storage device 225.

From these various memory units, the processing unit(s) 210 retrieves instructions to execute and data to process in order to execute the processes of the invention. The processing unit(s) may be a single processor or a multi-core processor in different embodiments.

The read-only-memory (ROM) 220 stores static data and instructions that are needed by the processing unit(s) 210 and other modules of the electronic system. The permanent storage device 225, on the other hand, is a read-and-write memory device. This device is a non-volatile memory unit that stores instructions and data even when the electronic system 200 is off. Some embodiments of the invention use a mass-storage device (such as a magnetic or optical disk and its corresponding disk drive) as the permanent storage device 225.

Other embodiments use a removable storage device (such as a floppy disk or a flash drive) as the permanent storage device 225. Like the permanent storage device 225, the system memory 215 is a read-and-write memory device. However, unlike storage device 225, the system memory 215 is a volatile read-and-write memory, such as a random access memory. The system memory 215 stores some of the instructions and data that the processor needs at runtime. In some embodiments, the invention's processes are stored in the system memory 215, the permanent storage device 225, and/or the read-only 220. For example, the various memory units include instructions for processing appearance alterations of displayable characters in accordance with some embodiments. From these various memory units, the processing unit(s) 210 retrieves instructions to execute and data to process in order to execute the processes of some embodiments.

The bus 205 also connects to the input and output devices 230 and 235. The input devices enable the user to communicate information and select commands to the electronic system. The input devices 230 include alphanumeric keyboards and pointing devices (also called “cursor control devices”). The output devices 235 display images generated by the electronic system 200. The output devices 235 include printers and display devices, such as cathode ray tubes (CRT) or liquid crystal displays (LCD). Some embodiments include devices such as a touchscreen that functions as both input and output devices.

Finally, as shown in FIG. 2, bus 205 also couples electronic system 200 to a network 240 through a network adapter (not shown). In this manner, the computer can be a part of a network of computers (such as a local area network (“LAN”), a wide area network (“WAN”), or an intranet), or a network of networks (such as the Internet). Any or all components of electronic system 200 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A system for assessing joint space narrowing; the system comprising:
a processor communicatively coupled to a display, non-transitory memory and a user input wherein the processor is configured with processor instructions for:
receiving at least two images and designating one image as a reference image and another image as a target image;
alternating whether the reference image or the target image is displayed on the display;
receiving common objects on the target image and the reference image from the user input;
embedding the common objects as anatomical landmarks on the reference image and the target image;
receiving transformation instructions from the user input changing an appearance of the target image; wherein some of the anatomical landmarks are identically aligned;
loading the transformation instructions into a transformation matrix; and
determining the joint space narrowing from the transformation instructions in the transformation matrix.

2. The system of claim 1, wherein the at least two images are obtained from or by one of: X-ray scattering, computer tomography, X-ray computed tomography and ultrasound.

3. The system of claim 1, wherein the processor instructions further comprise:
recalling previously tracked common objects from the non-transitory memory and displaying the previously tracked common objects on the display.

4. The system of claim 3, wherein the processor instructions further comprise:
clearing the common objects that have been tracked and tracking new common objects.

5. The system of claim 1, wherein the transformation instructions originate from one of specific keystrokes, mouse movements, manipulations using a track pad, or finger movements on a touchscreen to move either the target image or the reference image.

6. A non-transitory computer readable medium storing a program which when executed by at least one processing unit of a computing device assesses joint space narrowing; the program comprising sets of instructions for:
receiving at least two images and designating one image as a reference image and another image as a target image;
storing the reference image and the target image in non-transitory memory;
displaying the reference image and the target image on a display in an alternating manner;
placing common objects on the target image and the reference image from a user input;
embedding the common objects as anatomical landmarks on the reference image and the target image;
receiving transformation instructions from the user input changing an appearance of the target image; wherein some of the anatomical landmarks are identically aligned;
loading the transformation instructions into a transformation matrix; and
determining the joint space narrowing from the transformation instructions in the transformation matrix.

7. The non-transitory computer readable medium of claim 6, wherein the at least two images are obtained by obtained from or by one of: X-ray scattering, computer tomography, X-ray computed tomography and ultrasound.

8. The non-transitory computer readable medium of claim 6, further comprising recalling previously tracked common objects from the non-transitory memory and displaying the previously tracked common objects on the display.

9. The non-transitory computer readable medium of claim 6, further comprising clearing the common objects that have been tracked and tracking new common objects.

10. The non-transitory computer readable medium of claim 6, wherein the target image is displayed with a target image background color and the reference image is displayed with a reference image background color; wherein the target image background color is different from the reference image background color in order to distinguish the target image from the reference image.

11. The non-transitory computer readable medium of claim 6, further comprising:
embedding a target image region of interest on the target image
embedding a reference image region of interest on the reference image; and
calculating a match score by comparing the target image region of interest to the reference image region of interest;
wherein the match score determines how closely the target image region of interest is displayed compared to the reference image region of interest.

12. The non-transitory computer readable medium of claim 11, further comprising:
testing various combinations of translations and rotations until a highest match score is determined; and
displaying the combination with the highest match score.

13. The non-transitory computer readable medium of claim 6, further comprising producing a report providing the joint space narrowing.

14. The non-transitory computer readable medium of claim 13, wherein the report further comprises at least one of: reference data, graphs, figures to facilitate interpretation of the report.

15. The non-transitory computer readable medium of claim 6, further comprising providing quality assurance metrics to an operator.
